(19) United States
(12) Patent Application Publication
(10) Pub. No.: US 2025/0296645 A1
(43) Pub. Date: Sep. 25, 2025

(54) CATERPILLAR-INSPIRED SOFT CRAWLING ROBOT WITH DISTRIBUTED PROGRAMMABLE THERMAL ACTUATION

(71) Applicant: North Carolina State University, Raleigh, NC (US)

(72) Inventors: Yong Zhu, Raleigh, NC (US); Shuang Wu, Raleigh, NC (US)

(21) Appl. No.: 19/087,009

(22) Filed: Mar. 21, 2025

Related U.S. Application Data
(60) Provisional application No. 63/568,034, filed on Mar. 21, 2024.

(51) Int. Cl. B62D 57/032; B62D 29/04

(52) U.S. Cl. CPC B62D 57/032; B62D 29/043

(57) ABSTRACT

Various examples are provided related to soft crawling robots. In one example, a robot includes a bimorph structure including a liquid crystal elastomer (LCE) ribbon and a nanowire composite film; and electrical connections for coupling the nanowire network to a controlled low voltage source. The nanowire composite film includes a nanowire network forming conductive channels embedded below a surface of the nanowire composite film. Energizing a defined conductive channel can produce out-of-plane deformation in a portion of the bimorph structure to induce directional locomotion of the robot.

### CROSS REFERENCE TO RELATED APPLICATIONS

This application claims priority to, and the benefit of, U.S. provisional application entitled “Caterpillar-Inspired Soft Crawling Robot with Distributed Programmable Thermal Actuation” having Ser. No. 63/568,034, filed Mar. 21, 2024, which is hereby incorporated by reference in its entirety.

### STATEMENT REGARDING FEDERALLY SPONSORED RESEARCH OR DEVELOPMENT

This invention was made with government support under grant number IIP2122841 awarded by the National Science Foundation. The government has certain rights in the invention.

### BACKGROUND

Soft robots have attracted wide attention in biomedical engineering, surgical assistance, active prosthetics, camouflage, and perception technologies. Lots of inspiration have been taken from the animal world to incorporate soft materials with mechanical design for soft robotics, for example, octopus, fish, snakes, worms, and caterpillars. Some unique features of these animals, including multi-modal locomotion and passing through confined gaps, can be beneficial in complex and unstructured environments.

### SUMMARY

Aspects of the present disclosure are related to soft crawling robots. In one aspect, among others, a soft crawling robot comprises a bimorph structure comprising: a liquid crystal elastomer (LCE) ribbon; and a nanowire composite film disposed on a side of the LCE ribbon, the nanowire composite film comprising a nanowire network forming conductive channels embedded below a surface of the nanowire composite film; and electrical connections configured for coupling the nanowire network to a controlled low voltage source, where energizing a defined conductive channel produces out-of-plane deformation in a portion of the bimorph structure configured to induce directional locomotion of the robot. In one or more aspects, the nanowire network can comprise silver nanowires (AgNWs) in a composite matrix. The composite matrix can comprise polydimethylsiloxane (PDMS). The PDMS can be doped with carbon black (CB).

In various aspects, the nanowire composite film can be laminated to the LCE ribbon. The LCE ribbon can comprise mesogens aligned through tensile stretching. The nanowire network can comprise two symmetric parts, each symmetric part can comprise a first section adjacent to an end of the nanowire composite film and a second section adjacent to a center of the nanowire composite film. The second section can comprise first conductive channels each having a serpentine shaped conductive trace adjacent to an outer edge of the nanowire composite film and second conductive channels each having a thick straight trace between the first conductive channels. The first section can comprise a serpentine shaped conductive trace connected to the first and second conductive channels. The nanowire composite film can comprise a second nanowire network forming conductive channels embedded below a surface of the nanowire composite film, where energizing a defined conductive channel of the second nanowire network produces out-of-plane deformation in a second portion of the bimorph structure. The second nanowire network can comprise two symmetric parts, each symmetric part can comprise a first section adjacent to an end of the nanowire composite film and a second section adjacent to a center of the nanowire composite film. The second section can comprise first conductive channels each having a serpentine shaped conductive trace adjacent to an outer edge of the nanowire composite film and second conductive channels each having a thick straight trace between the first conductive channels. The two nanowire networks can be mirror symmetric about a center of the bimorph structure.

In another aspect, a method for crawling movement of a robot comprises initiating out-of-plane deformation of a portion of a bimorph structure comprising a liquid crystal elastomer (LCE) ribbon and a nanowire composite film disposed on a side of the LCE ribbon by energizing a defined conductive channel of a nanowire network of the nanowire composite film, the nanowire network forming conductive channels embedded below a surface of the nanowire composite film; and relaxing the portion of the bimorph structure by de-energizing the defined conductive channel of the nanowire composite film, where the out-of-plane deformation and relaxation induces directional locomotion of the robot. In one or more aspects, the method can comprise repeating the out-of-plane deformation of the portion of a bimorph structure by energizing the defined conductive channel and relaxing the portion of the bimorph structure by de-energizing the defined conductive channel to induce continuous directional locomotion of the robot. The method can comprise initiating out-of-plane deformation of the portion of the bimorph structure by energizing a second defined conductive channel of the nanowire network of the nanowire composite film; and relaxing the portion of the bimorph structure by de-energizing the second defined conductive channel of the nanowire composite film, where the out-of-plane deformation and relaxation induces directional locomotion of the robot in a different direction.

In various aspects, the method can comprise initiating out-of-plane deformation of a second portion of the bimorph structure by energizing a defined conductive channel of a second nanowire network of the nanowire composite film, the second nanowire network forming conductive channels embedded below the surface of the nanowire composite film; and relaxing the second portion of the bimorph structure by de-energizing the defined conductive channel of the second nanowire network, where the out-of-plane deformation and relaxation induces directional locomotion of the robot. The directional locomotion of the robot induced by out-of-plane deformation and relaxation of both portions of the bimorph structure can be in a uniform direction or different directions. The method can comprise alternating between out-of-plane deformation and relaxation of the portion of the bimorph structure and out-of-plane deformation and relaxation of the second portion of the bimorph structure. The method can comprise initiating out-of-plane deformation of the second portion of the bimorph structure by energizing a second defined conductive channel of the second nanowire network of the nanowire composite film; and relaxing the second portion of the bimorph structure by de-energizing the second defined conductive channel of the second nanowire network, where the out-of-plane deformation and relaxation induces directional locomotion of the robot in a different direction.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B illustrate forward and reverse locomotion of a caterpillar, in accordance with various embodiments of the present disclosure.

FIGS. 1C and 1D include images showing examples of forward and reverse locomotion of a soft crawling robot, in accordance with various embodiments of the present disclosure.

FIGS. 1E and 1F include infrared and perspective view images of the soft crawling robot with current injected for forward and reverse locomotion, in accordance with various embodiments of the present disclosure.

FIG. 2A illustrates an example of a fabrication process of a soft crawling robot, in accordance with various embodiments of the present disclosure.

FIG. 2B illustrates a cross-section of a soft crawling robot fabricated using the process of FIG. 2A, in accordance with various embodiments of the present disclosure.

FIG. 2C is an image of a fabricated soft crawling robot, in accordance with various embodiments of the present disclosure.

FIG. 3A is an image illustrating actuator sections of a soft crawling robot, in accordance with various embodiments of the present disclosure.

FIG. 3B is a schematic diagram of the equivalent electrical circuit of the two-channel actuator sections of FIG. 3A, in accordance with various embodiments of the present disclosure.

FIG. 3C includes images of bimorph cantilever curvature before and after energizing an actuator section, in accordance with various embodiments of the present disclosure.

FIGS. 3D-3F illustrate curvature of the bimorph cantilever with respect to time at different currents and thickness ratios and a comparison to theoretical curvature, in accordance with various embodiments of the present disclosure.

FIGS. 3G-3I illustrate temperature of the bimorph cantilever with respect to time at different currents and thickness ratios and a relationship between curvature and temperature, in accordance with various embodiments of the present disclosure.

FIGS. 4A and 4B illustrate a comparison of images and simulation results of the soft crawling robot in forward and reverse modes, in accordance with various embodiments of the present disclosure.

FIGS. 4C and 4D illustrate the simulation results of friction forces on two ends of the soft crawling robot in forward and reverse modes normalized by the self-weight of the robot, in accordance with various embodiments of the present disclosure.

FIGS. 5A and 5B illustrate examples of locomotion speed of the soft crawling robot in forward and reverse modes with different currents and actuation frequencies, in accordance with various embodiments of the present disclosure.

FIGS. 5C and 5D illustrate examples of locomotion speed at different currents/constant frequency and different frequencies/constant current, in accordance with various embodiments of the present disclosure.

FIGS. 5E and 5F illustrate examples of locomotion displacement of the soft crawling robot in forward and reverse modes, in accordance with various embodiments of the present disclosure.

FIG. 6A includes images illustrating a transition from actuator A to actuator B of the soft crawling robot, in accordance with various embodiments of the present disclosure.

FIG. 6B includes overlapping images illustrating the history of motion of FIG. 6A and obstacles that the robot can pass under, in accordance with various embodiments of the present disclosure.

FIGS. 6C and 6D include images illustrating the soft crawling robot and a confined tunnel under an obstacle through which the robot passes in forward and reverse modes, in accordance with various embodiments of the present disclosure.

### DETAILED DESCRIPTION

Disclosed herein are various examples related to soft crawling robots. A caterpillar-inspired, energy-efficient crawling robot with multiple crawling modes, enabled by thermal actuation of a soft bimorph actuator composed of silver nanowire/polymer composite and liquid crystal elastomer (LCE). With patterned and distributed heaters and programmable heating, different temperature and hence curvature distribution can be achieved, enabling bidirectional locomotion because of the friction competition between the front and rear end with the ground. The thermal bimorph behavior is studied to predict and optimize the local curvature of the robot under thermal stimuli. The bidirectional actuation modes, the crawling speed, and the capability of passing through obstacles with limited spacing are investigated by experiments and finite element analyses. Distributed and programmable heating and actuation with thermal responsive materials offers new capabilities for smart and multifunctional soft robots. Reference will now be made in detail to the description of the embodiments as illustrated in the drawings, wherein like reference numbers indicate like parts throughout the several views.

Researchers have also been exploring different actuation methods for soft robots using a variety of stimuli, including pressure, heat, electrical field, magnetic field, and chemical potential. Among the various types of stimuli, electric stimulus is one of the simplest and most convenient, where electroactive polymers, either ionic or field activated, are widely used. For electrically stimulated actuators, the ionic activation typically operates in an electrolyte environment while the field activation requires high voltage (>1 kV). Another type of electrically stimulated actuator, thermal bimorph actuator, is based on the mismatch in coefficient of thermal expansion (CTE) of two materials, has drawn much attention due to programmable operation, lightweight, low actuation voltage, being electrolyte-free, and potential for untethered operation (e.g., via wireless charging).

Among different thermal responsive materials, liquid crystal elastomer (LCE), a thermally driven actuating material that combines polymer network and liquid crystal mesogens, has recently attracted much attention because of its unique properties, including large (˜40%) and reversible actuation, high processability, and programmability. As the temperature increases, liquid crystal mesogens transition from the nematic phase to the isotropic phase, leading to a notable and macroscopic deformation in the material. A variety of LCE-based actuators have been designed and fabricated, which are often actuated by direct environmental heating, photothermal effects, and electrothermal actuation. However, for most practical applications, electronically powered actuators provide notable convenience for system control and integration. Stretchable resistive heaters can be integrated with LCE for better control with electrical signals.

A caterpillar-inspired bidirectional crawling robot with multiple locomotion modes, enabled by joule heating of distributed programmable silver nanowire (AgNW) heaters in an LCE-based thermal bimorph actuator, is presented here. With the designed AgNW heating pattern and programmable heating, different temperature distributions and curvature distributions can be achieved, resulting in different friction competition between the front and rear ends with the ground and hence bidirectional locomotion. To demonstrate the function of the crawling robot in potential applications, the performances in forward and reverse locomotion were characterized and a scenario of passing through a confined gap was tested. The locomotion modes, the crawling speed, and the ability of passing through obstacles with small gap have been studied with experiment and finite element analysis.

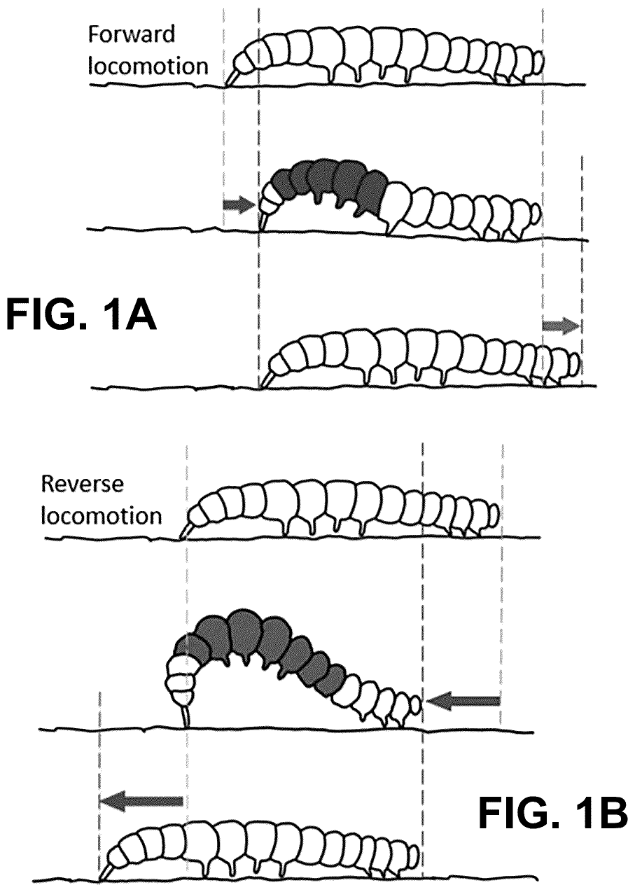

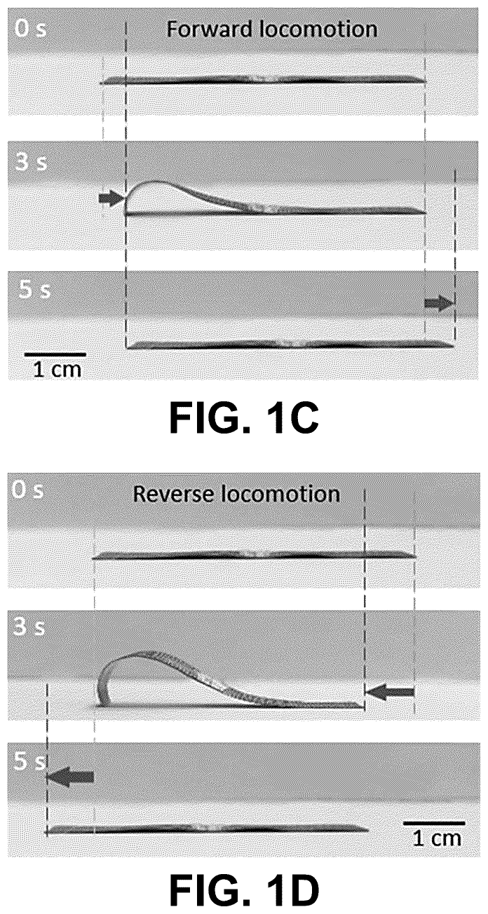

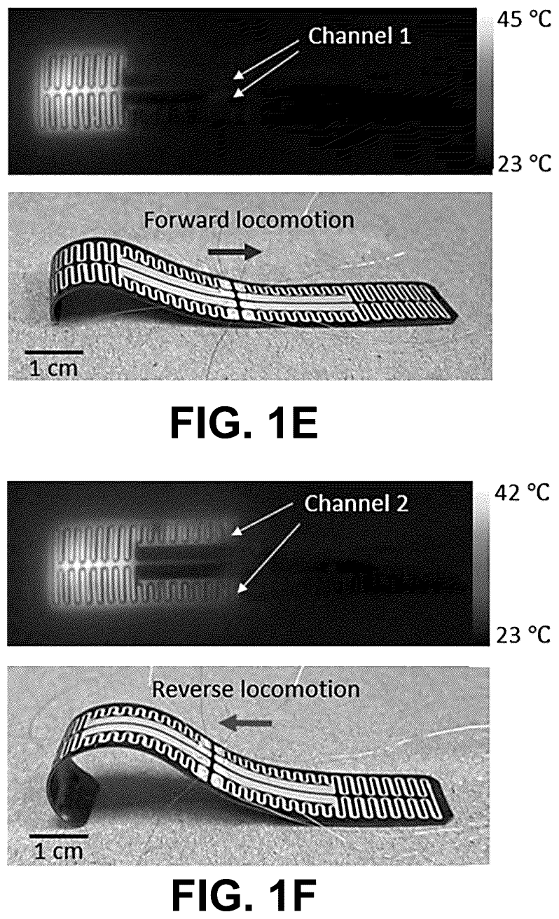

In nature, the mother-of-pearl moth, Pleurotya ruralis, exhibits two-directional locomotion. During the forward locomotion, the caterpillar contracts a few hind segments while anchoring the front to move the tail forward, producing a characteristic traveling hump on the back. Subsequently it releases the hump while anchoring the terminal tip. The entire caterpillar becomes flat again and as a result moves one step forward. FIG. 1A schematically illustrates the forward locomotion of a caterpillar. During the reverse locomotion, the caterpillar anchors the terminal tip on the ground followed by a powerful contraction of the middle part of the body. This motion produces a large hump that arches up the whole body. Then while anchoring the front part, the caterpillar releases the hump, becoming flat again and moving one step backward. FIG. 1B schematically illustrates the reverse locomotion of a caterpillar. The control of the body curvature enables the two-directional movement. While the caterpillar kinematics involve more sophisticated active control of the body parts at different segments, a caterpillar inspired crawling robot that can control the local curvature of the body can mimic the same two-directional movement.

FIGS. 1C and 1D include images showing one cycle of actuation for forward and reverse locomotion of a crawling robot, respectively, when different heating channels (or patterns) are heated. When the heater is turned off, relaxation of the bent bimorph structure brings the actuator either forward or backward to finish one cycle of locomotion. FIGS. 1E and 1F show the corresponding infrared images and tilted views of the actuator when Channels 1 and 2 are heated, respectively. In FIGS. 1C and 1D, a constant current applied to the inner two electrodes (Channel 1) and outer two electrodes (Channel 2) lead to the forward and reverse locomotion, respectively. For FIG. 1E, a 0.05 A current was injected in Channel 1, and for FIG. 1F, a 30 mA current was injected in Channel 2.

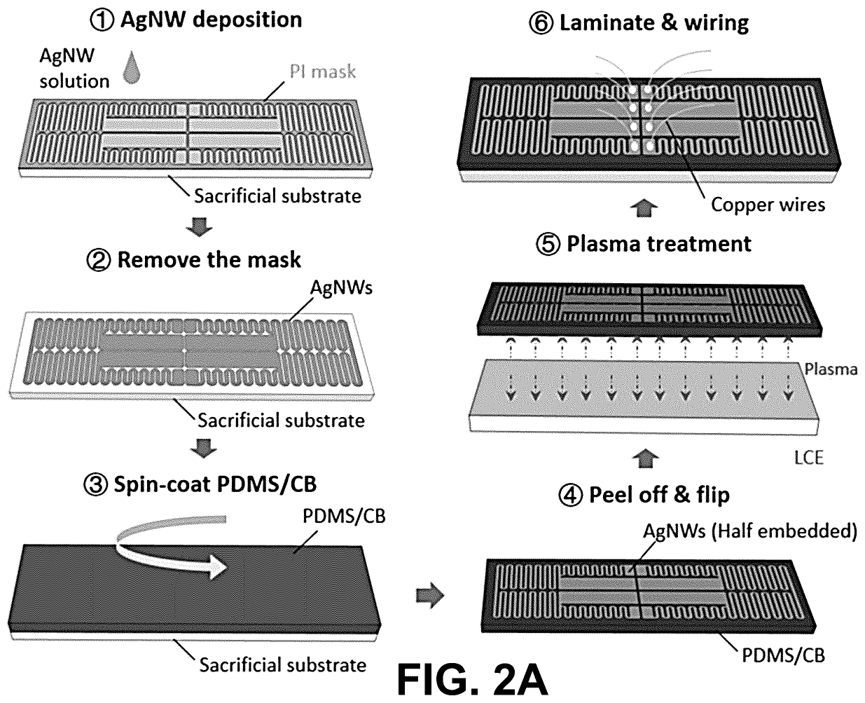

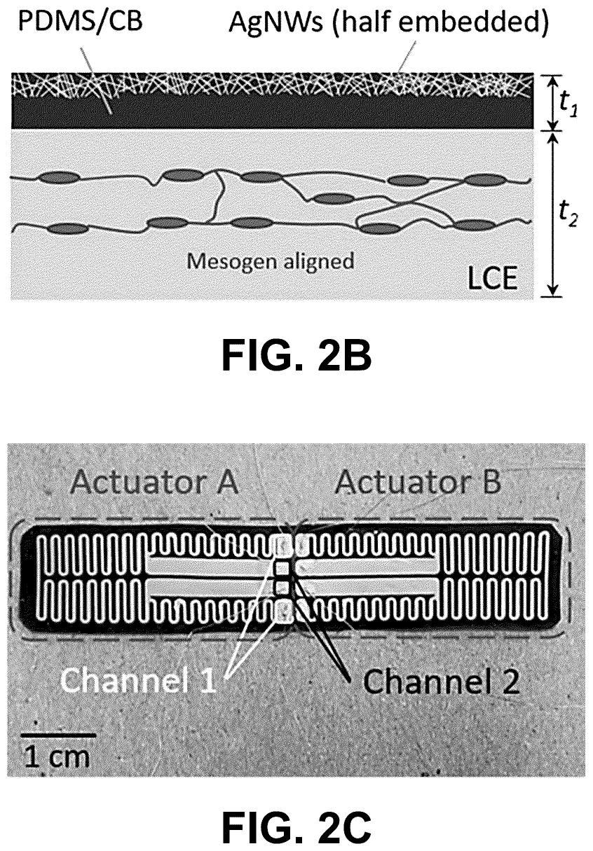

FIG. 2A illustrates an example of a fabrication process of the crawling robot. AgNWs can be used as a heating material in soft devices due to their excellent electric conductivity and mechanical compliance. In this work, AgNWs were used as the heating element, embedded just below the surface of a polydimethylsiloxane (PDMS) matrix. The crawling robot is a bimorph structure with a AgNW/PDMS and Carbon black (CB) composite film laminated on top of an LCE ribbon. Beginning at (1) in FIG. 2A, the AgNW pattern can be defined by drop casting AgNW solution on top of a masked sacrificial substrate (e.g., a PI mask on a Si substrate). The AgNWs were in the form of a percolation network structure. CB powders can be doped inside the PDMS precursor to enhance thermal conductivity. The mask is removed at (2) in FIG. 2A. Then at (3), liquid PDMS/CB composite can be dropped on top of the AgNW network and cured. The AgNW network was half embedded below the top surface of the PDMS/CB composite matrix. FIG. 2B is a cross-sectional view of the fabricated sample. Note that the thermal conductivity of PDMS/CB (with weight ratio of 4:1) was increased by 31% when compared with pure PDMS, but no obvious change of Young's modulus (<2%).

The sacrificial substrate is removed and the AgNW/PDMS/CB composite film is flipped at (4) in FIG. 2A before being attached to the LCE strip at (5). The LCE ribbon was fabricated by mechanical stretching of a rectangular flat LCE strip synthesized by two stage polymerization. The mesogens in the LCE ribbon are aligned through tensile stretching as illustrated in FIG. 2B. Plasma treatment and mechanical pressure were applied at (5) in FIG. 2A to form strong bonding between the AgNW/PDMS/CB composite film and the LCE ribbon. Electrical connections for operation of the soft crawling robot can then be made at (6) in FIG. 2A.

When electric current is applied to the AgNW network, heat is generated as a result of Joule heating and transferred to the PDMS/CB composite layer and the LCE layer. As shown in FIG. 2B, the half embedded AgNW structure is above the PDMS/CB and LCE layers. This is because the PDMS/CB surface can form stronger bonding with the LCE surface than the AgNW/PDMS/CB surface. As the AgNW/PDMS/CB layer is relatively thin (e.g., 60 μm), this configuration does not sacrifice much of the heating efficiency. When the temperature increases, the PDMS/CB composite expands due to thermal expansion, while the LCE layer shrinks due to the nematic-isotropic transition. FIG. 2C is an image showing the top view of the crawling robot with two symmetric actuators (A and B). Each actuator contains two conductive channels (1 and 2). By designing the AgNW heater pattern and hence tailoring the temperature distribution, different kinematics of the crawling robot can be achieved.

The performance of the bidirectional locomotion entails three major aspects: the heater performance, the frictional force analysis, and the effect of the amplitude and frequency of the power supply.

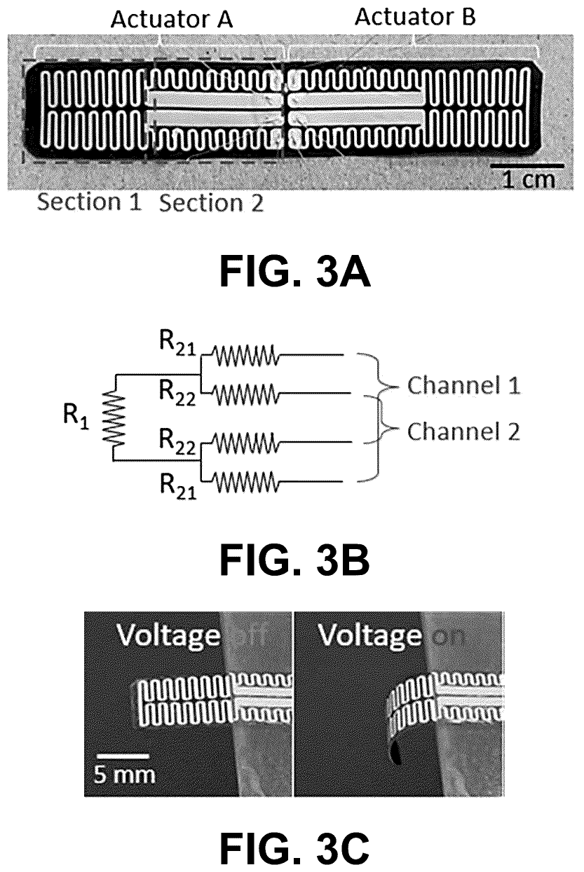

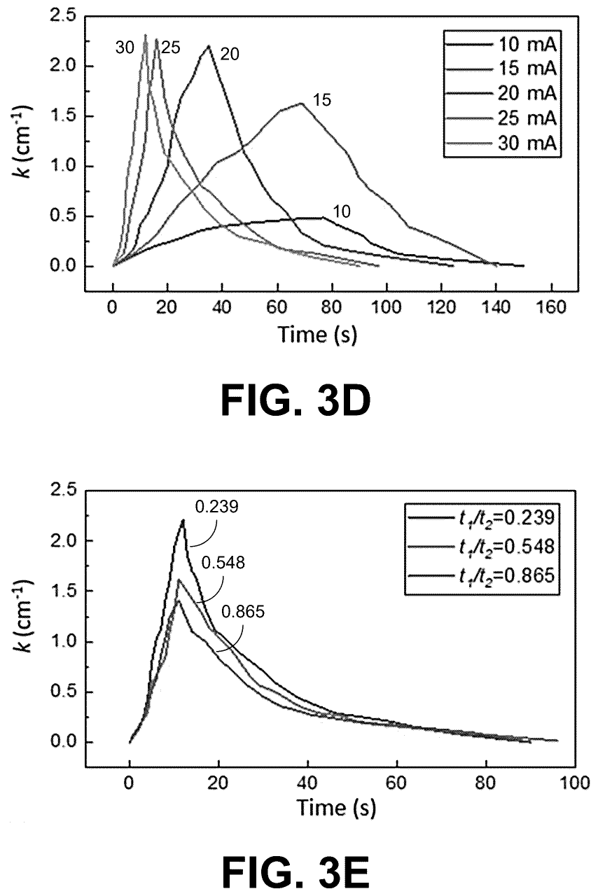

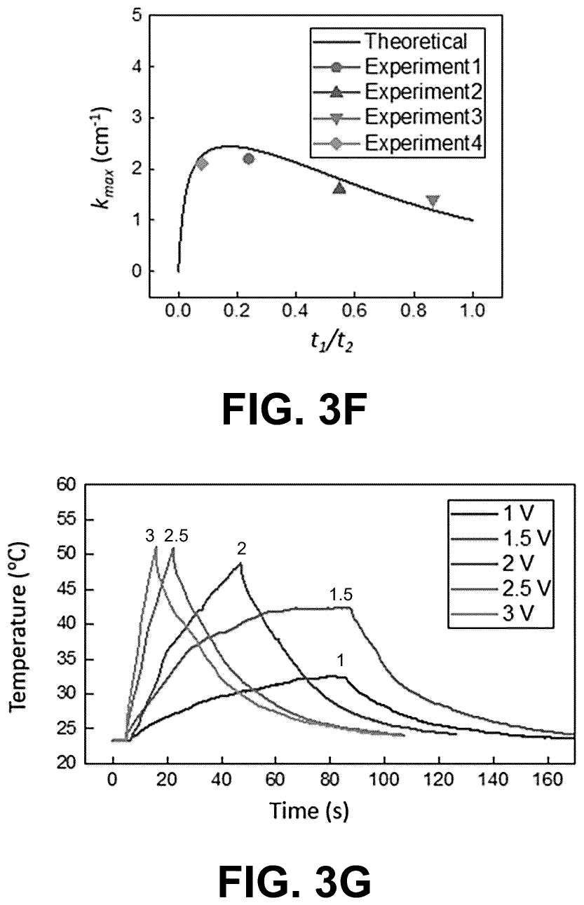

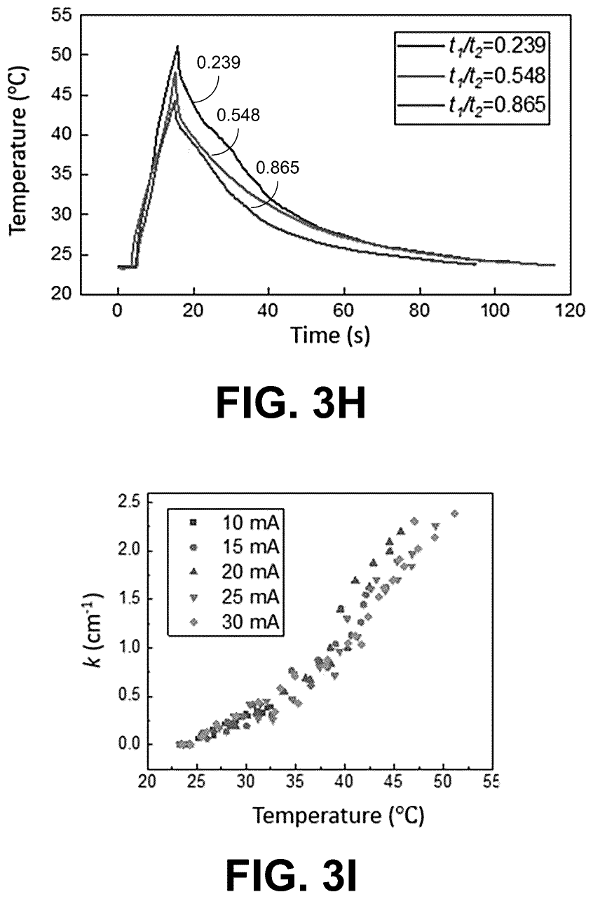

The conductive AgNW pattern is composed of two symmetric parts, each containing two sections, as shown in the image of FIG. 3A. Section 1 is uniformly covered with a serpentine shaped conductive trace with line width of, e.g., 0.65 mm. Section 2 is composed of two groups, each containing a thin serpentine trace (e.g., 0.65 mm in width) and a thick straight line (e.g., 2.4 mm) in parallel. The equivalent circuit model of the two-channel electrical circuit corresponding to the heating pattern is shown in FIG. 3B. In this study, the as-fabricated AgNW/PDMS composite layer has a uniform sheet resistance of 0.5 Ωsq⁻¹. The resistance components as shown in FIG. 3B are R₁=115.4Ω, R₂₁=38.8Ω, and R₂₂=3.2Ω. As a result, Channel 1 has a resistance of 193Ω and Channel 2 has a resistance of 121.8Ω.

To characterize the heating and actuation performance of the crawling robot, a parametric study was conducted on the effect of the electrical current and the bilayer thickness ratio between the AgNW/PDMS/CB film and the LCE ribbon (t1/t2), with Section 1 of the device cantilevered on a fixed boundary. FIG. 3C includes images showing the bimorph before (left) and after (right) the heater was turned on. FIG. 3D shows the curvature of the sample (with constant t1/t2=0.239) as a function of time under different currents from 10 to 30 mA. With the increasing current, the heating time significantly dropped from 80 to 12 s. Of note is that the power supply was stopped when the curvature reached the maximum value of 2.3 cm⁻¹ (the sample bent into a circle). FIG. 3E shows the curvature with respect to time with different thickness ratios (t1/t2=0.239, 0.548, 0.865). With the same applied current (25 mA) and the same heating time, the sample with t1/t2=0.239 yields the largest bending curvature. The curvature of a bimorph can be calculated with the Timoshenko's equation:

$$k = \frac{6 ( {α}_{1} - {α}_{2} ) ( T - {T}_{0} ) {( 1 + m )}^{2}}{ℏ [ 3 {( 1 + m )}^{2} + ( 1 + mn ) ( {m}^{2} + \frac{1}{mn} ) ]} \qquad ( 1 )$$

where

$$m = \frac{{t}_{1}}{{t}_{2}}$$

with t₁ and t₂ as the thicknesses of the two layers (i.e., the AgNW/PDMS/CB layer and LCE layer, respectively),

$$h = {t}_{1} + {t}_{2} , n = \frac{{E}_{1}}{{E}_{2}}$$

with E₁ and E₂ as the Young's moduli of the two layers, T₀ is the initial temperature, T is the temperature of the actuator, and α₁ and α₂ are the coefficients of thermal expansion of the two layers, respectively. CTE of PDMS is 3.1×10⁻³° C.⁻¹ (derived from the data sheet of Dow Inc.). CTE of LCE is −2.24×10⁻³° C.⁻¹ (derived from the measured strain/temperature relationship of fabricated LCE ribbon from room temperature to 45° C.). Of note is that the temperature T is from the IR measurement on the top of the actuator. There is a small temperature gradient in the thickness direction (˜0.3° C.). Therefore, the theoretically predicted curvature is slightly overestimated. But the curvature difference caused by such a small temperature difference is negligible. To provide the first-order guide to the design, a simplified model was used with uniform temperature in the thickness direction.

FIG. 3F plots the theoretical prediction of the curvature according to equation (1) and the experimental results, which agreed well. Note that in equation (1), the Young's modulus contribution from AgNWs was neglected since the AgNW embedded layer is only 3 μm, while the whole PDMS/CB layer is generally 20 times thicker. The Young's modulus of LCE was measured by uniaxial tensile testing. Thus, in the following discussion, t1/t2=0.239 was chosen for the bending actuation. Similarly, the temperature with respect to time was plotted for different current and different thickness ratios (FIGS. 3G and 3H, respectively). The temperature of the bimorph was taken using an IR camera focusing on the top surface of the PDMS/CB composite area. Finally, the curvature as a function of the temperature for the samples with t1/t2=0.239 is plotted in FIG. 3I.

A nonlinear relationship can be seen even though equation (1) predicts a linear relationship. This can be explained by the nonlinear relationship between α₂ and the temperature. It can be shown that α₂ in the LCE layer gradually increases with the increase of temperature from room temperature to 75° C. and then starts to decrease until 145° C. As a result, the curvature of the bimorph structure shows a slope increase when the temperature rises within the range shown in FIG. 3I. With the increase of the temperature, the Young's modulus of the LCE also increases but with negligible influence on the curvature based on equation (1).

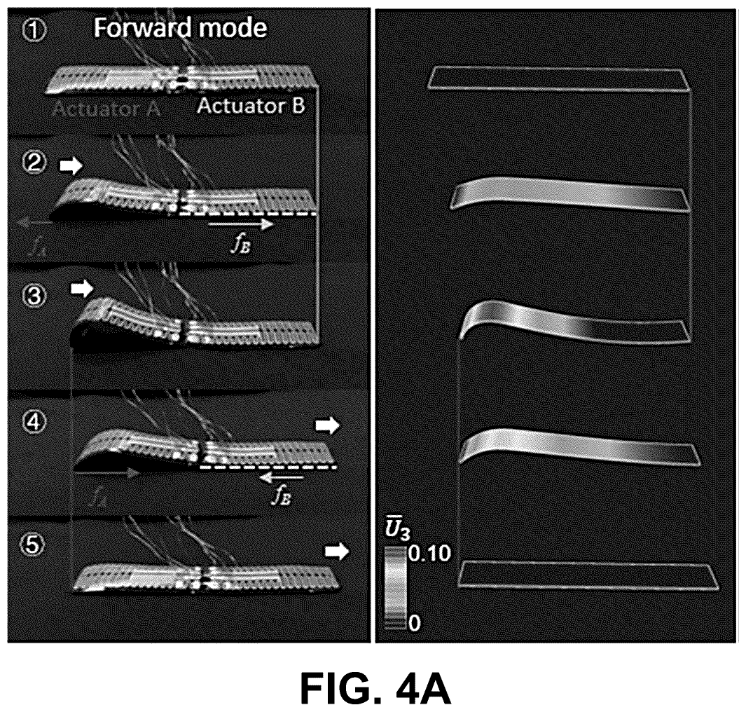

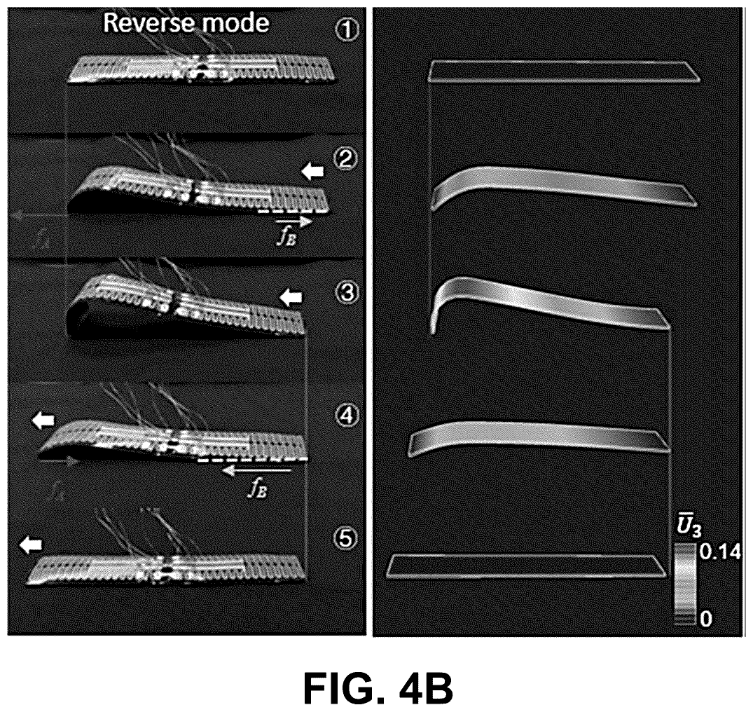

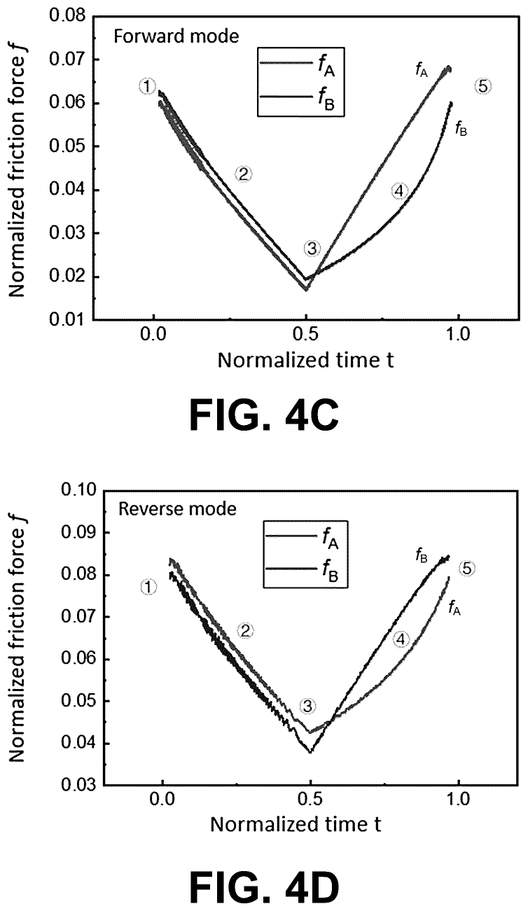

In FIG. 4A, the left panel shows snapshots of the forward locomotion mode of the caterpillar robot and the right panel shows a color bar representing the normalized out-of-plane deformation. In snapshot (2), when Channel 1 of Actuator A (left half of the robot) is activated (forward mode), Actuator A starts to arch and causes a friction competition between the left end and the right end (f_{A} and f_{B}). Due to the asymmetry of the arc shape, f_{A} is hypothesized to increase and reach the sliding friction criteria before f_{B} does. As a result, the left end slides rightward while the right end stays stationary. When the power is off, relaxation of the asymmetric arc shape causes the friction forces f_{A} and f_{B} to switch direction simultaneously and start a new competition. This time, f_{B} reaches the sliding friction first and starts to move rightward, while the left end is anchored until the whole robot returns to the initial flat state. Similarly, the left panel of FIG. 4B shows reverse mode of Actuator A when Channel 2 of Actuator A is activated and the right panel shows a color bar representing the normalized out-of-plane deformation. In snapshot (2), the asymmetric arch shape shows a very different curvature distribution compared with snapshot (2) in FIG. 4A. In reverse mode, more of the middle part of the robot is lifted up leaving a smaller contact area between the right end and the ground. Such a difference in contact area with the ground results in an opposite friction competition outcome. Snapshots (2) and (3) show that f_{B} reaches the sliding force first. The right end continues to move leftward while the left end stays anchored. Similarly, when the power is off, relaxation of the arch shape leads to leftward motion of the left end while the right end stays anchored.

To validate the hypothesis above, finite element analysis (FEA) was conducted using Abaqus/CAE. The soft crawler was modeled as a bilayer 3D deformable structure and the ground was modeled as a rigid surface. A friction coefficient (0.3) was applied between the bottom and side surfaces of the crawler and the substrate. The coefficient of friction was experimentally measured by dragging the deformed crawling robot on the substrate. The defined heating area was the same as observed from the IR images in experiment. The snapshots of the simulated results agree very well with experimental results in terms of locomotion direction and relative out-of-plane displacement (U̅₃̅ normalized by the length of the actuator). The friction forces on the two ends of the crawling robot were extracted from the simulation and normalized by the self-weight of the robot. FIGS. 4C and 4D illustrate the friction force on the two ends of the crawling robot in forward mode and reverse mode normalized by the self-weight of the robot. Point \textcircled{2} in FIG. 4C (forward mode) shows that f_{A}<f_{B}, which causes the sliding of the left end. However, starting from point \textcircled{3}, f_{A} increases more than f_{B} and causes the right end of the crawling robot to slide on the ground. In reverse mode of FIG. 4D, f_{A}>f_{B} in the first half of actuation cycle. When the power is off, f_{A} drops below f_{B} for the rest of the actuation cycle. Hence, reverse mode shows a completely opposite direction of locomotion compared with forward mode. The opposite sliding sequence of Actuator A and Actuator B is a result of different centroid location and touching angle with the ground when the robot bends to a different shape. The simulation results validated the friction competition mechanism of the crawling robot when distributed heating is applied.

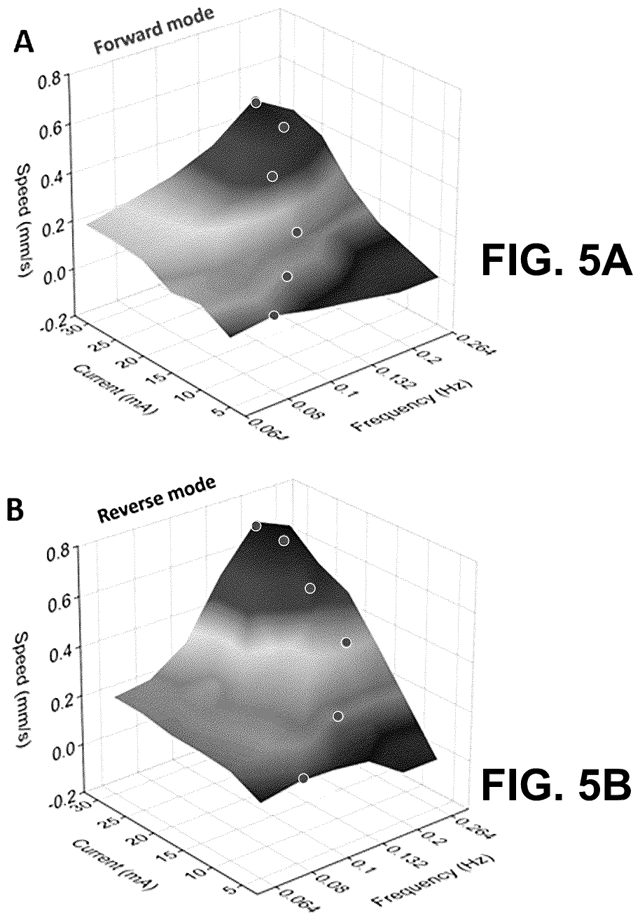

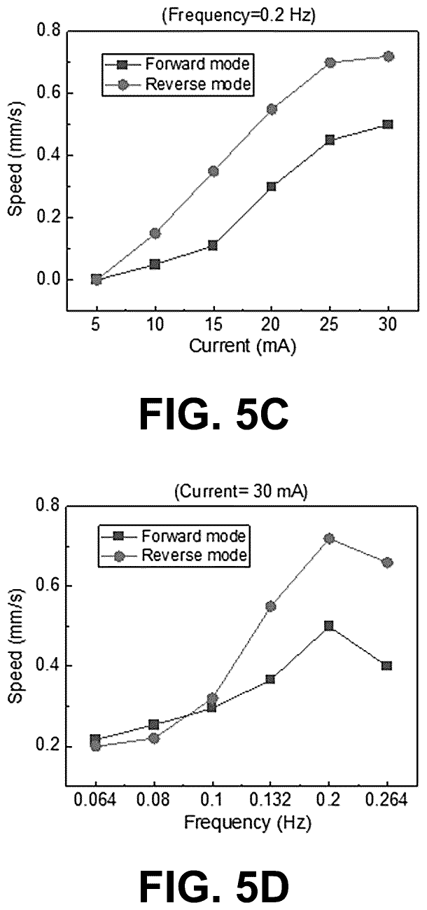

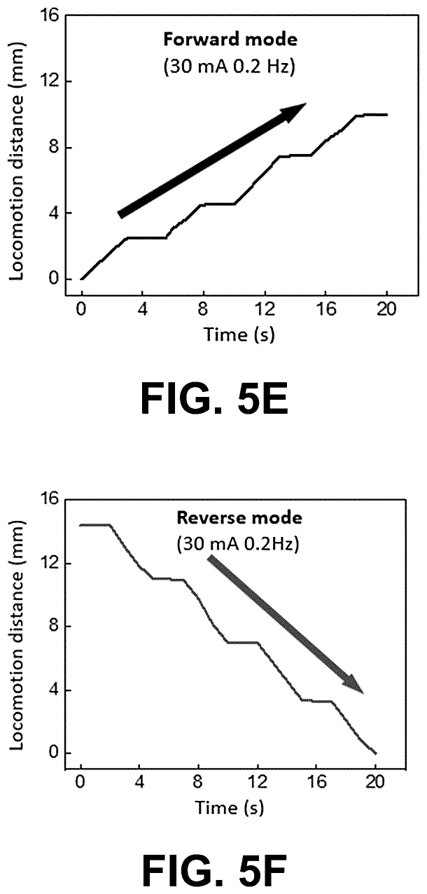

FIGS. 5A and 5B illustrate the locomotion speed (in forward mode and reverse mode, respectively) of the crawling robot as a function of the applied current (from 5 to 30 mA) and actuation frequency (from 0.064 to 0.264 Hz). In general, both forward and reverse mode show increasing speed when the applied current increases. This can be observed more clearly in the Speed vs. Current plot shown in FIG. 5C at a constant actuation frequency of 0.2 Hz. But in terms of Speed vs. Frequency, the locomotion speed first increases with the increasing actuation frequency but then decreases as shown in FIG. 5D at a constant current of 30 mA. When it reaches the maximum value (highlighted in dots in FIGS. 5A and 5B), a further increase of the frequency decreases the locomotion speed. This is due to the minimum heating and cooling time needed during each actuation cycle. It is straightforward that when the actuation frequency is low, the locomotion speed is low. However, when the frequency is too high, within each cycle the time for cooling is too short for the crawling robot to become flat again or even the time for heating is not sufficient to reach the target curvature. As a result, the locomotion speed drops.

FIGS. 5E and 5F illustrate examples of the locomotion displacement of the crawling robot in forward and reverse modes, respectively. Compared with the forward mode, reverse mode is generally faster. As shown in FIGS. 5E and 5F, under 30 mA and 0.2 Hz, the speed of the forward and reverse locomotion is 0.5 and 0.72 mm/s (0.008 and 0.012 BL/s), respectively. This is because in reverse mode, a larger part of the robot contracts and generates a longer stride for each crawling step, consistent with the caterpillar locomotion. The actuation speed of thermal actuators can be further improved with faster thermal response (e.g., reducing the LCE thickness and increasing its thermal conductivity) or introducing some mechanical designs, for example, the instability design. For comparison, the reported speed of the forward and reverse locomotion using the same electrothermal actuation mechanism and LCE material is 0.032 and 0.021 mm/s (0.0011 and 0.0008 BL/s), respectively.

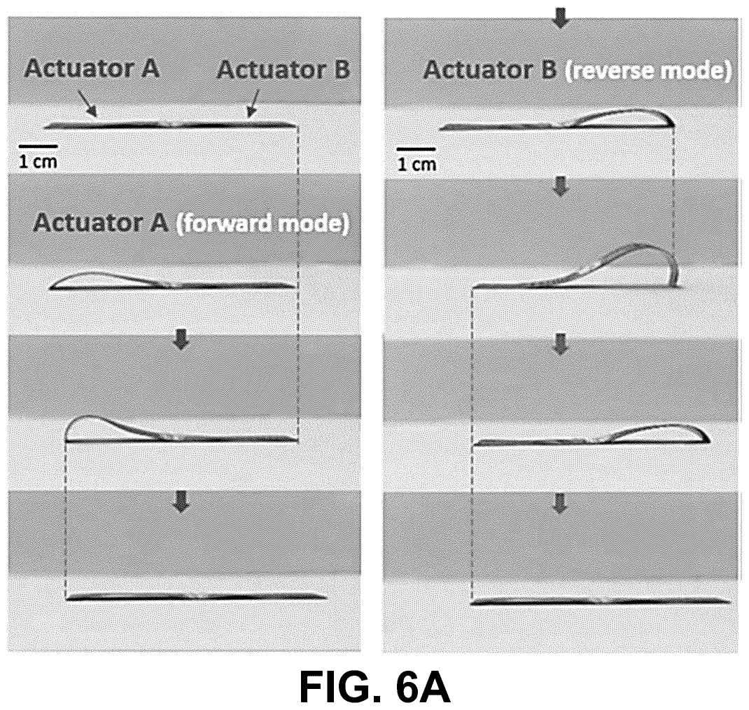

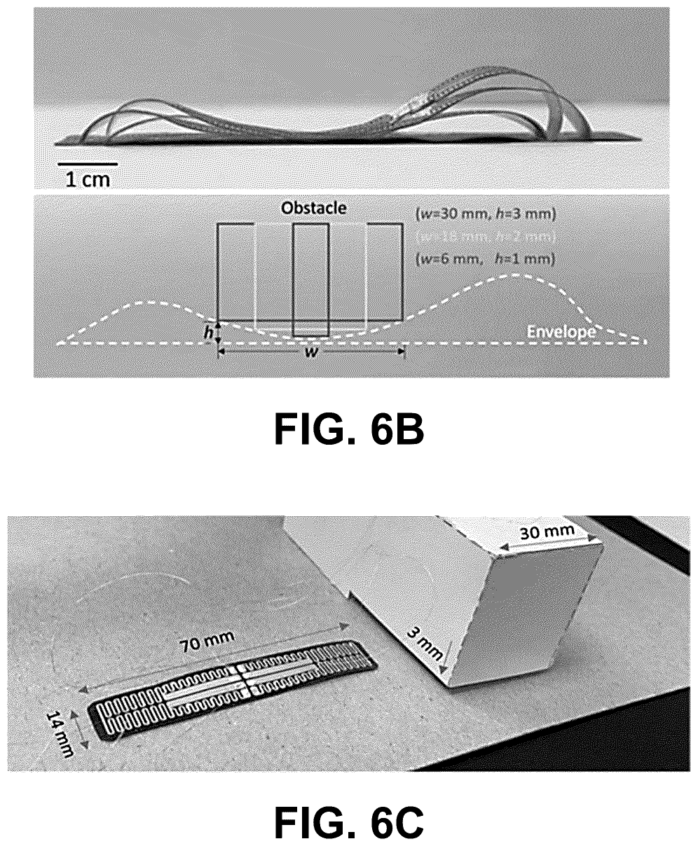

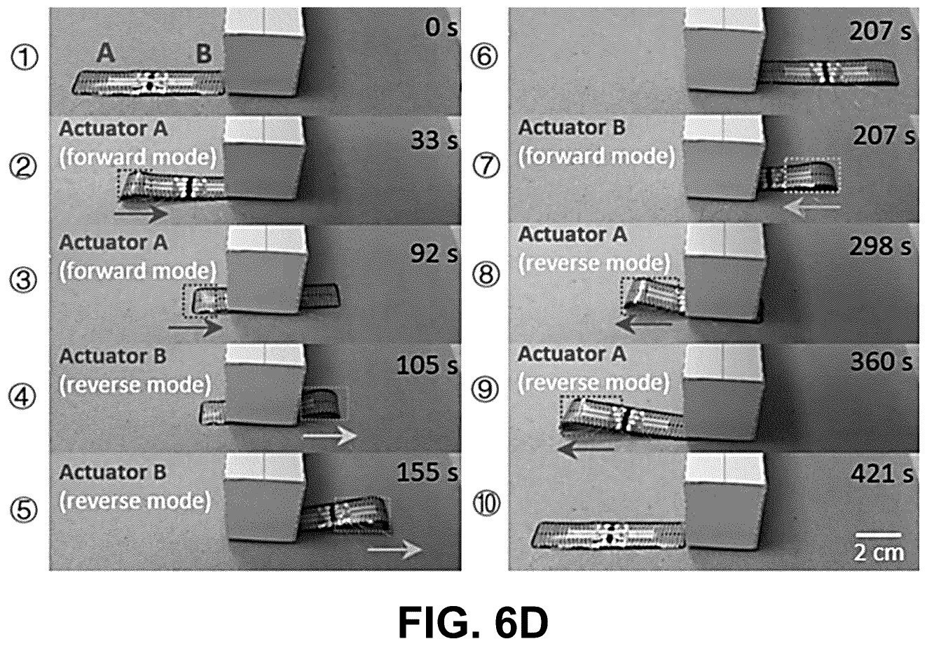

Finally, due to the symmetric two-actuator design (e.g., FIG. 2C) in the crawling robot and the 2-directional locomotion capability for each actuator, the application of the soft crawling robot was demonstrated by passing through small, confined space with a much lower gap height than that of the robot. FIG. 6A shows images of the side view of the crawling robot in motion—it starts with Actuator A with a current applied to Channel 2 for one cycle and then switches to Actuator B with a current applied to Channel 1 for another cycle. Because of the symmetricity of the two actuators, this actuator transition together with mode transition does not change the moving direction for the whole device. By overlapping all the snapshots during this entire motion, an envelope contour can be observed (dashed line in FIG. 6B) that reveals a deep valley in the middle. This interesting body profile can facilitate the crawling robot to pass under obstacles with confined space. The schematic in FIG. 6B shows a few examples of the obstacles (rectangular boxes) that the robot can pass beneath. The capability of passing through a confined space can be predicted from the envelope contour of the crawling robot with different voltage applied.

As shown in FIG. 6C, a confined tunnel was set up with a height of only 3 mm and length of 30 mm. Of note is that with no constraint the maximum height of the crawling robot can reach up to 8.9 mm in forward mode and 14.5 mm in reverse mode. FIG. 6D shows snapshots of the robot passing through this confined tunnel and passing back to return to the initial location. When the robot passes through, the actuators are operated just as described above and shown in FIG. 6A. When the robot retrieves, Actuator B changes from reverse mode to forward mode so that the robot gets pushed back into the tunnel. Then, Actuator A is turned on in reverse mode, which drives the body parts free of the geometrical constraint without changing the moving direction. Note that the multi-gait capability is distinct for this soft robot from other soft crawlers under different actuations, where they are neither capable of changing their gaits to go through confined spaces nor able to move bidirectionally. This capability of passing through a small, confined space in forward and backward locomotion offers promising potential for many applications such as, e.g., search and rescue.

LCE ribbon fabrication. The LCE samples were synthesized by modifying previously reported thiol-acrylate Michael addition reaction method. The liquid crystal mesogenic monomer, 1,4-bis-[4-(3-acryloyloxypropyloxy)benzoyloxy]-2-methylbenzene (RM 257), was purchased from Wilshire Technologies and utilized without further modification. In a typical synthesis process, 2 g of RM 257 was first fully dissolved in 0.7 g of toluene at 85° C. with magnetic stirring, followed by cooling down to room temperature. The, 0.42 g of the chain extender 2,2′-(ethylenedioxy) diethanethiol (EDDET, Sigma Aldrich), 0.18 g of crosslinker pentaerythritol tetrakis (3-mercaptopropionate) (PETMP, Sigma Aldrich), and 0.012 g of the photoinitiator (2-hydroxyethoxy)-2-methylpropiophenone (HHMP, Sigma Aldrich) were added in the solution. The solution was then well dissolved at 85° C. and cooled down to room temperature again. Subsequently, 0.288 g of the dipropyl amine (DPA, Sigma Aldrich) solution (2 wt %, in toluene) was added in the solution that serves as the catalyst. After being fully mixed and degassed, the solution was carefully poured in the prepared mold (length 9 cm, width 3 mm, depth 1 mm). Next, the mold was placed in a closed container overnight for fully reaction. A first-cured LCE sample can be obtained after dried at 80° C. for 1 d. When the LCE ribbon was fully dried, it was uniaxially stretched to 100% strain, followed by exposure to 365 nm ultraviolet (UV) irradiation at an intensity of 20 mJ/cm2 for 10 min.

Synthesis of AgNWs. First, 60 mL of a 0.147 M PVP (MW˜40000, Sigma-Aldrich) solution in EG was added to a flask, to which a stir bar was added; the solution was then suspended in an oil bath (temperature 151.5° C.) and heated for 1 h under magnetic stirring (150 rpm). Then 200 μL of a 24 M CuCl2 (CuCl2·2H2O, 99.999+%, Sigma-Aldrich) solution in EG was injected into the PVP solution. The mixture solution was then injected with 60 mL of a 0.094 M AgNO3 (99+%, Sigma-Aldrich) solution in EG.

Fabrication of the crawling robot. A patterned mask was made by laser cutting a thin PI film on top of a glass slide. Then the prepared AgNW solution was drop-casted on the masked glass slide, which was then placed onto a hot plate at 50° C. to evaporate the solvent. After the solvent was evaporated, the PI mask was removed together with AgNWs on top. Liquid PDMS (SYLGARD 184, DOW Inc.) with a weight ratio of 10:1 was mixed thoroughly with carbon black (weight ratio between liquid PDMS and carbon black was 4:1 and then dropped on top of the patterned AgNWs on glass slide. After spin coating, the PDMS/CB layer was controlled with uniform thickness. The AgNW/PDMS/CB composite was cured at 70° C. for 1 hour (13, 49). Then the PDMS/CB side of the composite film and the surface of prepared LCE ribbon was plasma treated for 20 s and then laminated together with pressure to form a strong bonding. The Cu wires were attached to the eight ends of the conductive patterns by silver epoxy (MG Chemicals).

FEA of the two crawling modes. The crawler is modeled as a bilayer 3D deformable part, while the ground is modeled as a rigid part. The geometry of all actuators was taken from experimental data and imported into Abaqus CAE and then meshed with solid quadratic tetrahedral elements (C3D10H). A mesh refinement study was applied to verify the accuracy of the mesh. The thermal expansion of the LCE elastomer is set to be orthotropic according to the prestretch direction in experiments, where the expansion coefficients are −0.1, 0, and 0 in the x, y, and z directions, respectively. An equal friction coefficient (0.3) is applied between the bottom and side surface of the crawler and the substrate to simulate the varying friction force induced by the morphology with a predefined temperature field applied during dynamic explicit analysis. The thermal expansion rate of the LCE elastomer is set to be orthotropic according to the prestretched direction in the experiment. Young's modulus of the LCE was taken from tensile experiment shown in FIG. S4. The Young's modulus of AgNW/PDMS is taken from Dow Inc. datasheet. The effect of AgNWs on the composite was neglected due to the minimal thickness ratio (<1:20).

Although crawling robots have been studied, most crawling robots only exhibit simple bending motion with constant curvature and only a few demonstrate bidirectional motion. For example, a bidirectional peristaltic crawling robot was implemented by sequential control of each segment. But this crawling robot required high voltage (6 kV) and sophisticated controls (collaborative control of four segments). Also, this robot was composed of rigid skeletons instead of completely soft materials. A vibration-driven biomimetic soft robot was also developed, where the two actuators were excited at different frequencies (1 Hz and 50 Hz, respectively). By switching the actuation frequency of the two actuators, the robot could move bidirectionally. However, the voltage required was still very high (800 V). A magnetic field driven actuator was shown which could switch crawling direction by changing the magnetic field. However magnetic field control is generally more complicated compared with electrothermal control. A bidirectional crawler comprising two heaters, one causing upward bending and the other downward bending, has also been implemented. Each locomotion, either forward or reverse, involves two heaters and four sequential steps to complete one stride (one cycle of crawling locomotion); the two heaters must be powered on and off following a coordinated sequence. Of note is that the upward/downward bending requires different stack orders of materials to construct the thermal bimorph which makes the device three layers instead of two, increasing the complexity of fabrication.

For comparison, the proposed methodology adopts distributed heating to control the local curvature of the crawling robot. The designed body profiles are inspired by the curvature distribution of a caterpillar, which can self-regulate the friction with the ground to achieve the 2-directional crawling. For each locomotion, only one actuator and two steps (simply power on and off of the actuator) are needed for one cycle of crawling locomotion. In addition, the energy efficiency of the crawling robot is much higher than that previously reported using an electrothermal actuation mechanism and LCE material. In short, the main features of the disclosed bioinspired soft crawler compared with other 2-directional crawlers include complete softness (no rigid parts), low voltage (less than 5 V), simple fabrication and control (square-wave input on one actuator at a time), dynamic body profile control (capability of passing through confined gaps with limited space), relatively fast speed and higher energy efficiency (for electrothermal actuation).

To sum up, a caterpillar-inspired, energy-efficient crawling robot with multiple crawling modes, enabled by joule heating of a patterned soft heater comprising AgNW networks in an LCE-based thermal bimorph actuator, was designed and fabricated. The different actuation modes are controlled by joule heating of designed AgNW heating patterns. With designed heating patterns and programmable heating, different temperature and curvature distribution can be achieved, resulting in different frictions between the front and rear ends with the ground. FEA was conducted to model the friction mechanism of the locomotion modes, which agreed very well with the experimental results. The locomotion speed of the two crawling modes (forward and reverse) as a function of the applied current and frequency were characterized. To demonstrate the crawling robot for potential applications, a scenario of passing through a confined gap with limited space was tested. The strategy of distributed and programmable heating with thermal responsive materials offers exciting new capabilities for smart and multifunctional soft robots.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A soft crawling robot, comprising:
a bimorph structure comprising:
a liquid crystal elastomer (LCE) ribbon; and
a nanowire composite film disposed on a side of the LCE ribbon, the nanowire composite film comprising a nanowire network forming conductive channels embedded below a surface of the nanowire composite film; and
electrical connections configured for coupling the nanowire network to a controlled low voltage source, where energizing a defined conductive channel produces out-of-plane deformation in a portion of the bimorph structure configured to induce directional locomotion of the robot.

2. The soft crawling robot of claim 1, wherein the nanowire network comprises silver nanowires (AgNWs) in a composite matrix.

3. The soft crawling robot of claim 2, wherein the composite matrix comprises polydimethylsiloxane (PDMS).

4. The soft crawling robot of claim 3, wherein the PDMS is doped with carbon black (CB).

5. The soft crawling robot of claim 1, wherein the nanowire composite film is laminated to the LCE ribbon.

6. The soft crawling robot of claim 1, wherein the LCE ribbon comprises mesogens aligned through tensile stretching.

7. The soft crawling robot of claim 1, wherein the nanowire network comprises two symmetric parts, each symmetric part comprising a first section adjacent to an end of the nanowire composite film and a second section adjacent to a center of the nanowire composite film.

8. The soft crawling robot of claim 7, wherein the second section comprises first conductive channels each having a serpentine shaped conductive trace adjacent to an outer edge of the nanowire composite film and second conductive channels each having a thick straight trace between the first conductive channels.

9. The soft crawling robot of claim 8, wherein the first section comprises a serpentine shaped conductive trace connected to the first and second conductive channels.

10. The soft crawling robot of claim 1, wherein the nanowire composite film comprises a second nanowire network forming conductive channels embedded below a surface of the nanowire composite film, where energizing a defined conductive channel of the second nanowire network produces out-of-plane deformation in a second portion of the bimorph structure.

11. The soft crawling robot of claim 10, wherein the second nanowire network comprises two symmetric parts, each symmetric part comprising a first section adjacent to an end of the nanowire composite film and a second section adjacent to a center of the nanowire composite film.

12. The soft crawling robot of claim 11, wherein the second section comprises first conductive channels each having a serpentine shaped conductive trace adjacent to an outer edge of the nanowire composite film and second conductive channels each having a thick straight trace between the first conductive channels.

13. The soft crawling robot of claim 10, wherein the two nanowire networks are mirror symmetric about a center of the bimorph structure.

14. A method for crawling movement of a robot, comprising:
initiating out-of-plane deformation of a portion of a bimorph structure comprising a liquid crystal elastomer (LCE) ribbon and a nanowire composite film disposed on a side of the LCE ribbon by energizing a defined conductive channel of a nanowire network of the nanowire composite film, the nanowire network forming conductive channels embedded below a surface of the nanowire composite film; and
relaxing the portion of the bimorph structure by de-energizing the defined conductive channel of the nanowire composite film, where the out-of-plane deformation and relaxation induces directional locomotion of the robot.

15. The method of claim 14, comprising repeating the out-of-plane deformation of the portion of a bimorph structure by energizing the defined conductive channel and relaxing the portion of the bimorph structure by de-energizing the defined conductive channel to induce continuous directional locomotion of the robot.

16. The method of claim 14, further comprising:
initiating out-of-plane deformation of the portion of the bimorph structure by energizing a second defined conductive channel of the nanowire network of the nanowire composite film; and
relaxing the portion of the bimorph structure by de-energizing the second defined conductive channel of the nanowire composite film, where the out-of-plane deformation and relaxation induces directional locomotion of the robot in a different direction.

17. The method of claim 14, further comprising:
initiating out-of-plane deformation of a second portion of the bimorph structure by energizing a defined conductive channel of a second nanowire network of the nanowire composite film, the second nanowire network forming conductive channels embedded below the surface of the nanowire composite film; and
relaxing the second portion of the bimorph structure by de-energizing the defined conductive channel of the second nanowire network, where the out-of-plane deformation and relaxation induces directional locomotion of the robot.

18. The method of claim 17, wherein the directional locomotion of the robot induced by out-of-plane deformation and relaxation of both portions of the bimorph structure is in a uniform direction.

19. The method of claim 18, comprising alternating between out-of-plane deformation and relaxation of the portion of the bimorph structure and out-of-plane deformation and relaxation of the second portion of the bimorph structure.

20. The method of claim 17, further comprising:
initiating out-of-plane deformation of the second portion of the bimorph structure by energizing a second defined conductive channel of the second nanowire network of the nanowire composite film; and
relaxing the second portion of the bimorph structure by de-energizing the second defined conductive channel of the second nanowire network, where the out-of-plane deformation and relaxation induces directional locomotion of the robot in a different direction.
